(19) United States
(12) Patent Application Publication
(10) Pub. No.: US 2008/0212759 A1
(43) Pub. Date: Sep. 4, 2008

(54) ANONYMITY ENGINE FOR ONLINE ADVERTISING, SALES AND INFORMATION DISTRIBUTION

(75) Inventor: Michael Bates, Paradise Valley, AZ (US)

Correspondence Address: COOLEY GODWARD KRONISH LLP;ATTN: Patent Group, Suite 1100, 777 - 6th Street, NW, WASHINGTON, DC, 20001, US

(73) Assignee: IQZONE, Scottsdale, AZ (US)

(21) Appl. No.: 12/024,894

(22) Filed: Feb. 1, 2008

Related U.S. Application Data
(60) Provisional application No. 60/887,775, filed on Feb. 1, 2007.

(51) Int. Cl. H04M 3/42

(52) U.S. Cl. 379/207.15

(57) ABSTRACT

Systems and methods for providing online sales and advertising are disclosed. A system may be configured to provide an online advertisement and, responsive to a received request for information regarding the advertisement from a potential buyer, provide information related to the advertisement to a seller to facilitate a sales transaction. The response may be facilitated by customized ANI processing.

### CROSS REFERENCE TO RELATED APPLICATIONS

This application claims priority under 35 U.S.C. § 119(e) to U.S. Provisional Patent Application Ser. No. 60/887,775, entitled ANONYMITY ENGINE FOR ONLINE ADVERTISING, SALES AND INFORMATION DISTRIBUTION, filed on Feb. 1, 2007. This application is related to U.S. Utility patent application Ser. No. 11/940,257 entitled SYSTEMS AND METHODS FOR ONLINE ADVERTISING, SALES, AND INFORMATION DISTRIBUTION, filed Nov. 14, 2007, and to U.S. Provisional Patent Application Ser. No. 60/865,817 entitled SYSTEMS AND METHODS FOR ONLINE ADVERTISING, SALES, AND INFORMATION DISTRIBUTION, filed on Nov. 14, 2006. The contents of each of these applications is hereby incorporated by reference herein in its entirety for all purposes.

### FIELD OF THE INVENTION

The present invention relates generally to online advertising, sales and information distribution, and particularly to systems and methods for processing and distributing online sales, advertising and information content in a variety of formats from a variety of sources.

### BACKGROUND

A range of services and associated systems are currently available for online sales, advertising and information distribution; however, most of the current providers exist as web sites requiring a web browser to use. Commonly known examples include providers such as Ebay and CraigsList. Posting items on existing sites can be difficult and time consuming. The time required to create an account, get a digital camera, take pictures or create other media, download the media to a computer, post the media and text, and choose the correct listing category can be significant, and in some cases the process may take an hour or even longer. Even users that have become adept at using existing web sites are likely to spend substantial time and effort getting their items or information posted. At the same time there has been a proliferation of cell phones and other handheld devices incorporating digital cameras and other media capture devices that allow for faster capture and download of information such as text, photographs, video clips or other media. This has created a need for simpler and more efficient ways of capturing content and quickly creating and processing online advertisements, sales listings or other online information.

The present invention addresses these and other needs by allowing users to simply point and click to capture images or other media content associated with items to be listed and then enter and send a description of the item. The information is received and processed to quickly provide listings based on categories such as item description or type, location and price. Users are able to quickly review and edit listings, search for content or information, and provide alerts or messages to a variety of devices. Users are also able to customize delivery of information related to customer contacts through a contact processing system that delivers contact information to users in a variety of ways using telecommunication identification services such as automatic number identification (ANI).

### SUMMARY

Systems and methods for accepting, processing, and displaying sales, advertising and other types of information are disclosed. User-provided information such as advertisements, sales information or related content may originate from a variety of different sources in a variety of formats including text as well as hybrid content. Information may be easily added to an available information display or distribution system or may be further processed to allow for analysis, parsing, display or distribution of information.

The information may undergo one or more processing steps including intelligent processing in order to determine the best course of action to maintain the best possible user experience, while also requiring a minimum of data and time from the user. Responses to customer contacts can be customized by processing ANI information and creating rules based redirection of customer contacts that can be dynamically reconfigured by a user. Customer contacts can be delivered to users via a variety of means including by telephone call forwarding, text messaging, email and other communication means.

### BRIEF DESCRIPTION OF THE DRAWINGS

The foregoing aspects and the attendant advantages of the embodiments described herein will become more readily apparent by reference to the following detailed description when taken in conjunction with the accompanying drawings wherein:

FIG. 1 illustrates one embodiment of a user customizable advertising system according to aspects of the present invention.

FIG. 2 illustrates the workflow of one embodiment of the present invention for assigning a telephone number and processing rules to a product advertisement.

FIG. 3 illustrates a workflow and user interaction with one embodiment of the invention.

### DETAILED DESCRIPTION

The systems and methods described herein are applicable to a wide range of applications involving input, display, storage, processing, transmission, delivery and other aspects of sales, advertising and information handling and processing. For purposes of explanation, the following description is provided with reference to specific nomenclature and implementation details; however, it will be apparent to one skilled in the art that specific details described are not required in order to practice the invention, and that other embodiments in keeping within the spirit and scope of the present invention are possible.

This application is related to U.S. Utility patent application Ser. No. 11/940,257 entitled SYSTEMS AND METHODS FOR ONLINE ADVERTISING, SALES, AND INFORMATION DISTRIBUTION, filed Nov. 14, 2007, to U.S. Provisional Patent Application Ser. No. 60/887,775 entitled ANONYMITY ENGINE FOR ONLINE ADVERTISING, SALES AND INFORMATION DISTRIBUTION, filed on Feb. 1, 2007, and to U.S. Provisional Patent Application Ser. No. 60/865,817 entitled SYSTEMS AND METHODS FOR ONLINE ADVERTISING, SALES, AND INFORMATION DISTRIBUTION, filed on Nov. 14, 2007. The contents of each of these application is hereby incorporated by reference herein in its entirety for all purposes. These applications may be denoted collectively herein as the “related applications” for purposes of brevity.

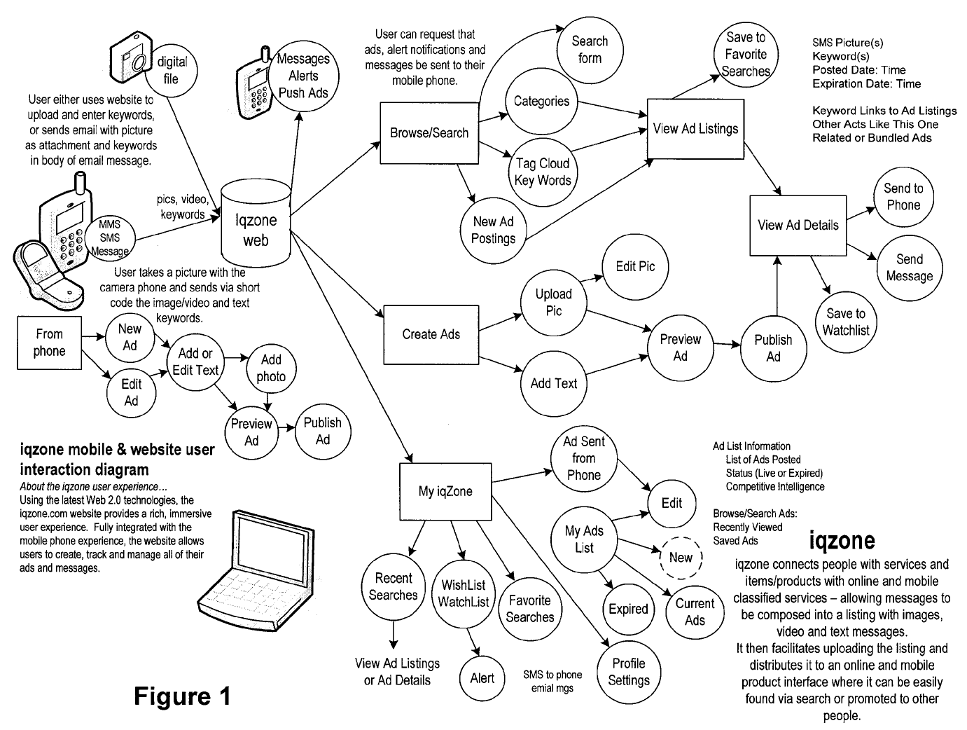

Aspects of the present invention relate to sales of products and services, (collectively denoted herein as “products”), wherein products are advertised and sales transactions conducted with the assistance of the wired telephone system (POTS) and/or wireless telephone system (denoted herein collectively as the “phone system”) and/or the Internet. As described in the related applications, and illustrated in FIG. 1, a user may create, download, store, process, display, edit and otherwise interact with a product advertisement using systems and methods based on the phone system and the Internet. In addition, a user may complete sales or other transactions related to the product advertisement over the same type of system. User interaction with the phone system may include transactions that include transmission and receipt of audible information such as speech, as well as text messaging. Text messaging may be done via a variety of text messaging devices and services such as the short message service (SMS or colloquially SMSes, texts or TXTS) for short text messages, multimedia messaging service (MMS) for longer text, graphics, photos, audio clips, video clips and the like, or by other services.

In some embodiments of the present invention, a system may be configured so that a product seller (denoted herein as a “user”) may create a product advertisement as shown in FIG. 1, such as a listing of an item for sale, and may then have a temporary telephone number assigned to the product so that a potential purchaser of the product (denoted herein as a “buyer”) may call to learn more about the product and/or purchase the product. The system may further be configured to allow the user to choose whether to maintain anonymity by limiting access by the buyer to the user's email address, telephone number or other user associated information. A user may also be able to configure processing of the buyer's call by the system using a rules engine so that information related to a buyer's contact with the system (buyer's call to assigned telephone number or other unique identifier) may be directed to a seller in one or more ways as further detailed below.

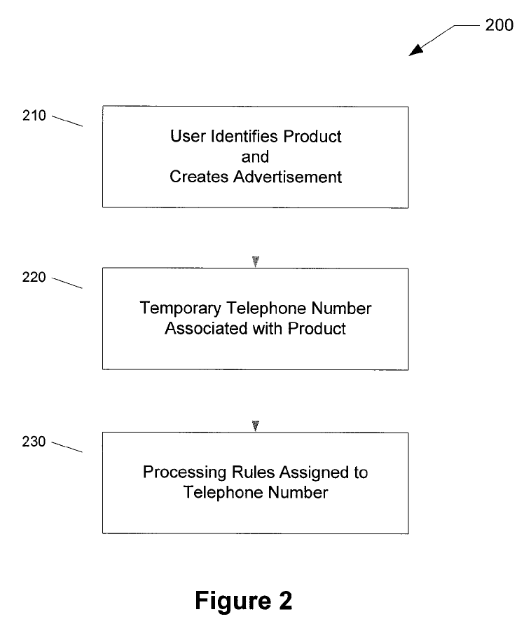

FIG. 2 illustrates one embodiment of a workflow 200 of the present invention. As shown in FIG. 2, a user may first identify a product to be advertised and then create an advertisement or other product related information in step 210. The advertisement may be created by a system such as that shown in FIG. 1 and described in the related applications. For example, a user may have an item he wishes to sell such as a BMW automobile. Based on information such as a description of the automobile, year, color, condition and the like the user may create an advertisement that may include text, speech or other audio content, pictures, video or other related information that may then be stored and be made accessible in a system such as is described in the related applications.

In conjunction with or after creating and uploading an advertisement, a user may be assigned a temporary telephone number in step 220 that is associated with the product advertisement. For example, a block of telephone numbers that are re-assignable may be used in a telephone number management system that assigns numbers to newly listed product advertisements as they become available and reallocates numbers associated with expired product advertisements as they expire. The telephone number may be assigned to the product advertisement in a variety of ways including displaying the telephone number in the product listing, providing a link to the telephone number or otherwise making the telephone number available to the buyer.

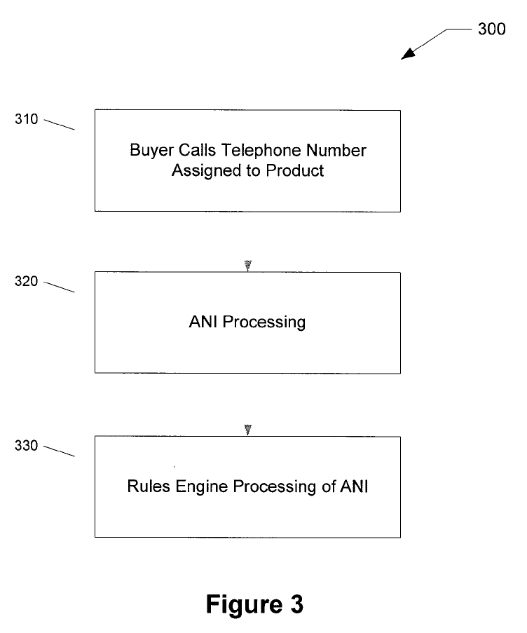

In addition, a user may be able to configure a rules engine system in step 230 to control processing of calls made to the telephone number associated with the product advertisement. Additional description of a rules engine system is provided below with reference to FIG. 3.

FIG. 3 illustrates an embodiment of a user interaction with the present invention. As described previously, a user may create a product advertisement and have a telephone number assigned to the advertisement. A buyer may then contact the assigned telephone number in step 310 and the call may be directed to an identification processing module such as ANI processing module 320. As is commonly known in the telecommunications field, a feature of telephony services called Automatic Number Identification (ANI) may be available which permits subscribers to display or capture the telephone numbers and related information of calling parties. ANI information may include text strings that contain the captured information, and the ANI information may be delivered to a ANI based service subscriber.

Certain aspects of the present invention are directed to further processing of the ANI information by augmenting and/or replacing the ANI text string. In some embodiments as shown in FIG. 3, a system may include an ANI processing module 320 configured to process the ANI information to include a custom text string related to a particular product. Processing in module 320 may include augmentation of provided ANI information and/or replacement of provided ANI information with custom text strings or other custom identifiers. In some embodiments each product will be assigned a unique telephone number or other identifier as a means of identification. ANI processing module 320 receives the ANI information and processes the text string by adding information related to the product or replaces the string with new text related to the product. The augmented or replacement text may be based on the telephone number being called, the intention and means of connection of the particular caller, the calling number or other transaction related information. In some embodiments the rules engine will replace some or all of the ANI caller ID text with specific text strings related to or describing the product. For example, product identification text may be added to or substituted for the incoming calling or called number information that describes which product is being requested. Examples of substituted product identification strings include IQ BMW Ad (for a BMW sales advertisement), IQ Bicycle Red (for a red bicycle sale ad), or IQ Bowie Tickets (for David Bowie concert tickets).

Once the processed ANI information has been generated, the call may be directed to a rules engine processing module 330 and/or to related modules to further process the call based on user configurable options. Users are able to set up an initial configuration and also reconfigure the rules processing module based on a variety of parameters as described below. In some embodiments databases such as calling name and/or address database information may be used and may be correlated with demographic information to create additional text and/or audio message information to be included with information provided by the rules engine processing module or related modules. The rules engine processing module 330 may be configured to generate responses that direct buyers to particular results based on the type of product, caller phone type, caller service capabilities (such as voice only, SMS, MMS, etc.) and the like. The system may allow users to have incoming calls redirected or forwarded to any mobile or fixed telephone number, such as the user's cell phone number, home phone number, business phone or other number. The system may also be configured to originate an SMS or MMS message to a non-wireless number without wireless carrier affiliation and to then further transport the message after being processed by the rules engine to any variety of mobile devices designated by the rules engine.

In some embodiments the rules engine may be configured to allow a user to further control call processing by directing responses to different phone numbers or mediums (i.e. telephone, email) depending on temporal parameters such as the time of day, day of the week and the like. For example, a user may configure the rules engine to direct a call about a particular product, such as the BMW described previously, to a business number or voicemail box from 9 AM to 5 PM, and after 5 PM direct the call to a home phone number. Text messages, such as SMS and MMS, may also be selectively directed in a similar manner.

In some embodiments the rules engine may be configured to allow a buyer to request additional information associated with the product advertisement, such as by MMS (for delivery of additional text, photos, or video). For example, a buyer may be prompted as to whether she would like to receive additional information about the advertised product such as photos or videos. If she responds affirmatively, the system sends the additional information in response.

Aspects of embodiments of the present invention may be further described by way of illustrative example. It is noted that the telephone numbers described below are for example only and are not meant to be limiting in any way.

In one exemplary transaction, a user creates an advertisement for a BMW automobile (BMW Ad) and is assigned a product specific telephone number by the system (in this example, (602) 555-1000). A potential buyer then makes a call from her telephone number, (202) 555-1212, to the product advertisement phone number, (602) 555-1000, to respond to the advertisement. The ANI processing module generates a replacement ANI ID that will display text related to the product advertisement, such as IQzone BMW 202 555 1212. In creating the product advertisement, the user may configure the rules engine to process the incoming calls from the buyer in a variety of ways. For example, the user may configure the rules engine to forward the call to his personal or business telephone number, (602) 555-1212. The ANI replacement text is inserted and the call is then forwarded to the user's selected telephone number. The user then receives the forwarded call and based on the replaced ANI the user instantly knows what the call is related to and can determine if he wishes to process the call.

In a different transaction, the same or another buyer may send a text message from (202) 555-1212 to IQzone Ad (602) 555-1000 BMW Ad. In creating the product advertisement, the user may configure the rules engine to forward the text message to a particular email address, for example username@hotmail.com. The system will receive the call and incoming ANI information and combine some or all of the incoming information with some or all of the product advertisement information and forward an email containing the combined information to the designated user email address. Some or all of the combined information may be included in the body or subject area of the email. For example, an email may be sent to the user with subject text reading “SMS from IQzone BMW 202 555 1212.”

In some embodiments the processing engine may allow a user to notify a caller, via text message, voice, email or other means, that a product has been sold or an advertisement has been cancelled. In addition, the processing engine may allow a user to redirect a caller to similar or alternate items for sale. For example, if a product is no longer available the system may notify a buyer that “the product or service is no longer available,” that “an item has been sold,” and/or that “similar items are available at [source phone #, web link, or other identifier].”

It is noted that in various embodiments the present invention may relate to processes such as are described or illustrated herein and/or in the related applications. These processes are typically implemented in one or more modules comprising systems as described herein and/or in the related applications, and such modules may include computer software stored on a computer readable medium including instructions configured to be executed by one or more processors. It is further noted that, while the processes described and illustrated herein and/or in the related applications may include particular stages, it is apparent that other processes including fewer, more, or different stages than those described and shown are also within the spirit and scope of the present invention. Accordingly, the processes shown herein and in the related applications are provided for purposes of illustration, not limitation.

Some embodiments of the present invention may include computer software and/or computer hardware/software combinations configured to implement one or more processes or functions associated with the present invention. These embodiments may be in the form of modules implementing functionality in software and/or hardware software combinations. Embodiments may also take the form of a computer storage product with a computer-readable medium having computer code thereon for performing various computer-implemented operations, such as operations related to functionality as describe herein. The media and computer code may be those specially designed and constructed for the purposes of the present invention, or they may be of the kind well known and available to those having skill in the computer software arts, or they may be a combination of both.

Examples of computer-readable media within the spirit and scope of the present invention include, but are not limited to: magnetic media such as hard disks; optical media such as CD-ROMs, DVDs and holographic devices; magneto-optical media; and hardware devices that are specially configured to store and execute program code, such as programmable microcontrollers, application-specific integrated circuits (“ASICs”), programmable logic devices (“PLDs”) and ROM and RAM devices. Examples of computer code may include machine code, such as produced by a compiler, and files containing higher-level code that are executed by a computer using an interpreter. Computer code may be comprised of one or more modules executing a particular process or processes to provide useful results, and the modules may communicate with one another via means known in the art. For example, some embodiments of the invention may be implemented using assembly language, Java, C, C#, C++, or other programming languages and software development tools as are known in the art. Other embodiments of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following claims and their equivalents define the scope of the invention.

1. A system for customer contact processing comprising:
a first component disposed to assign a temporary telephone number to an advertisement;
a second component disposed to modify identification information associated with an incoming call to said temporary telephone number, wherein said identification information is modified based on information related to said advertisement; and
a third component disposed to redirect said incoming call based on user definable preferences.

2. The system of claim 1 wherein said identification information comprises ANI information.

3. The system of claim 2 wherein said ANI information is modified to include text descriptive of said advertisement.

4. The system of claim 1 wherein said redirect of said incoming call comprises forwarding said incoming call to a user defined telephone number.

5. A method for customer call processing comprising:
receiving a call regarding an advertisement wherein said receiving includes receiving caller identification information;
modifying said identification information based on said advertisement; and
responding to said call based on a set of user specified preferences.

6. The method of claim 5 wherein said identification information comprises ANI information.

7. The method of claim 6 wherein said modification of said ANI information includes addition of descriptive information about said advertisement.

8. A system for customer contact processing comprising:
a first component disposed to assign a temporary telephone number to an advertisement;
a second component disposed to modify identification information associated with an incoming text message to said temporary telephone number, wherein said identification information is modified based on information related to said advertisement; and
a third component disposed to redirect said incoming call based on user definable preferences.

9. The system of claim 8 wherein said identification information comprises ANI information.

10. The system of claim 9 wherein said ANI information is modified to include text descriptive of said advertisement.

11. The system of claim 8 wherein said redirecting of said incoming call comprises forwarding said incoming text message to a user defined telephone number.

12. The system of claim 11 wherein said text message comprises an SMS message.

13. The system of claim 11 wherein said text message comprises an MMS message.
